(19) United States
(12) Patent Application Publication
(10) Pub. No.: US 2011/0260643 A1
(43) Pub. Date: Oct. 27, 2011

(54) ENERGY-SAVING MECHANISMS

(75) Inventors: Ming-Hsin HUANG, Baoshan Township (TW); Ke-Horng CHEN, Banqiao City (TW)

(73) Assignee: TAIWAN SEMICONDUCTOR MANUFACTURING COMPANY, LTD., Hsinchu (TW)

(21) Appl. No.: 12/764,410

(22) Filed: Apr. 21, 2010

(51) Int. Cl. H05B 37/02; G05F 3/00

(52) U.S. Cl. 315/294; 323/371

(57) ABSTRACT

Some embodiments regard a method comprising: using an input voltage to generate an output voltage having a first voltage level; in a first period, when the output voltage changes from the first voltage level to a second voltage level, storing electrical charges resulted from the output voltage changing from the first voltage level to the second voltage level; and in a second period subsequent to the first period when the output voltage demands energy, using a voltage generated from the stored electrical charges in place of the input voltage to generate the output voltage.

### FIELD

The present disclosure is generally related to saving energy, and, in some embodiments, the energy saving is used in multi-color Light-Emitting Diode (LED) backlights or displays.

### BACKGROUND

RGB (red, green, blue) LED backlights are commonly used to increase the gamut range of LED-backlit LCD televisions. Such RGB LEDs can also be used to directly display images in LED televisions (LED TVs). Each R, B, or G light or diode, however, requires a different turn-on voltage (e.g., the forward-bias voltage). As a result, when a same driving voltage is used to bias all R, G, and B LEDs in the same circuit, the R LEDs appear to consume much more power than the G and B LEDs. Various approaches use different techniques to reduce power consumption, but increase the size and cost for printed-circuit boards (PCBS) having the LEDs, due to additional components/circuitry. For example, one approach that uses three power converters, one for each R, G, and B LED also uses three inductors and numerous external components. Another approach uses a parallel driving structure, but with a complex transformer and two inductors. Another approach uses a single converter, but also uses a pulse-width modulator (PWM) current controller that consumes high power.

### BRIEF DESCRIPTION OF THE DRAWINGS

The details of one or more embodiments of the disclosure are set forth in the accompanying drawings and the description below. Other features and advantages will be apparent from the description, drawings, and claims.

FIG. 1 is a schematic diagram of a circuit that uses some embodiments.

FIG. 2 is a graph of waveforms related to some signals in the circuit of FIG. 1, in accordance with some embodiments.

FIG. 3 is a schematic diagram of the circuit in FIG. 1 in a boost mode, in accordance with some embodiments.

FIG. 4 is a graph of waveforms illustrating the relationship of some signals of the circuit in FIG. 3, in accordance with some embodiments.

FIG. 5 is a schematic diagram of the circuit in FIG. 1 in an energy recycle mode, in accordance with some embodiments.

FIG. 6 is a graph of waveforms illustrating the relationship of some signals of the circuit in FIG. 5, in accordance with some embodiments.

FIG. 7 is a schematic diagram of the circuit in FIG. 1 in a silence mode, in accordance with some embodiments.

FIG. 8 is a schematic diagram of the circuit in FIG. 1 in an energy transfer mode, in accordance with some embodiments.

FIG. 9 is a graph of waveforms illustrating an operation of the circuit in FIG. 1, in accordance with some embodiments.

FIG. 10 is a flow chart illustrating a method related to the circuit in FIG. 1, in accordance with some embodiments.

FIG. 11 is a graph of waveforms illustrating an advantage of the circuit in FIG. 1, in accordance with some embodiments.

Like reference symbols in the various drawings indicate like elements.

### DETAILED DESCRIPTION

Embodiments, or examples, illustrated in the drawings are now being disclosed using specific language. It will nevertheless be understood that the embodiments and examples are not intended to be limiting. Any alterations and modifications in the disclosed embodiments, and any further applications of the principles disclosed in this document are contemplated as would normally occur to one of ordinary skill in the pertinent art. Reference numbers may be repeated throughout the embodiments, but they do not require that feature(s) of one embodiment apply to another embodiment, even if they share the same reference number.

### EXEMPLARY CIRCUIT

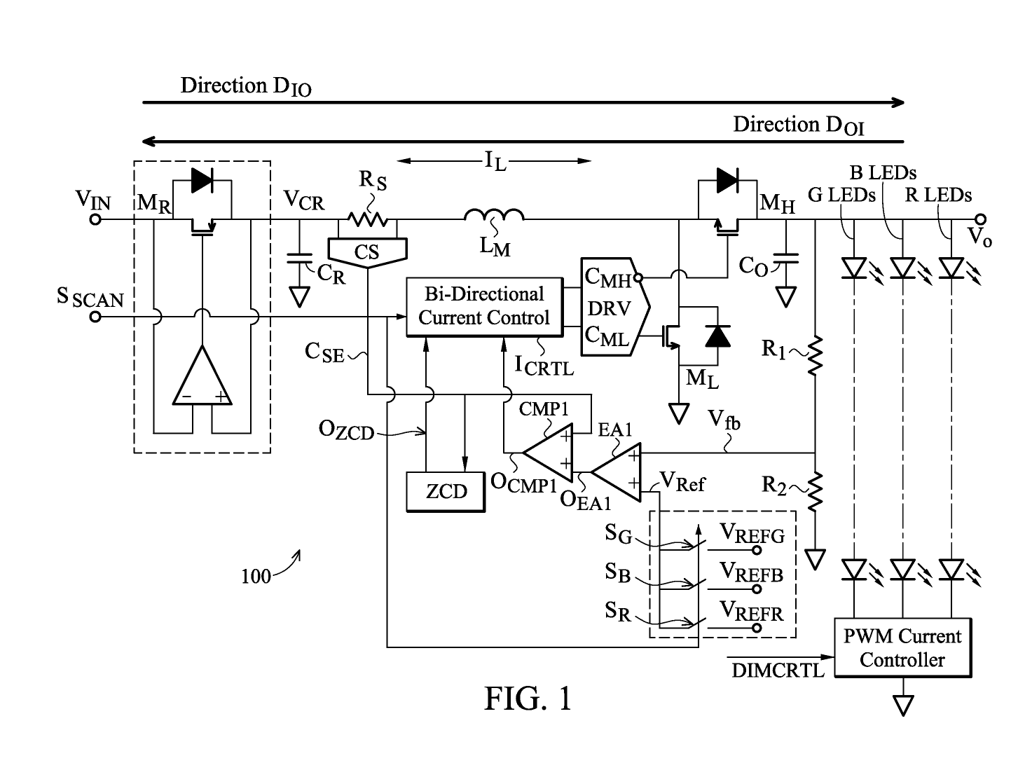

FIG. 1 is a diagram of an exemplary circuit 100 that uses some embodiments. Circuit 100 can be called a power converter, a power driver, etc. In some embodiments, circuit 100 operates in a cycle including a first boost mode, an energy recycling mode, a silence mode, an energy transfer mode, and a second boost mode. Voltage V_{IN} is a DC voltage around 12V. Additionally, when current I_{L} switches in the positive domain, current I_{L} flows in the direction from node V_{IN} towards node V_{O}, e.g., direction D_{IO}, and in the direction from node V_{O} towards node V_{IN}, e.g., direction D_{OI} when current I_{L} switches in the negative domain. For illustration, the symbol |I_{L}| refers to the amplitude of current I_{L}.

Active diode M_{R} controls the current flow between nodes V_{IN} and V_{CR}. When voltage V_{IN} is greater than voltage V_{CR}, diode M_{R} turns on allowing current to flow from node V_{IN} to node V_{CR}. But when voltage V_{IN} is lesser than voltage V_{CR} diode M_{R} turns off and thus electrically disconnects node V_{IN} from node V_{CR}. When diode M_{R} is on, voltage V_{CR} is lower than voltage V_{IN}, the voltage drop across diode M_{R}, which, in some embodiments, is about 0.2V. In some embodiments, diode M_{R} is turned on/off automatically based on the relationship between voltages V_{IN} and V_{CR}. For example, initially in the first boost mode during a display of one or more LEDs of a first color, e.g., the B LED (blue LED), when there is no current I_{L}, voltage V_{CR} is 0V, V_{IN} at about 12V is greater than V_{CR} and thus turns on diode M_{R}. Current I_{L} then flows. But when current I_{L} increases causing V_{CR} to increase until V_{CR} is greater than V_{IN} diode M_{R} turns off. Active diode M_{R} is used for illustration only, a conventional diode or equivalent circuitry can be used.

Capacitor or energy tank C_{R} stores energy when output voltage V_{O} drops (e.g., from 40V to 26V) and increases voltage V_{CR} in the energy recycle mode. After the energy is recycled, it is later used, e.g., to drive the LEDs. For example, in the energy-transfer mode, voltage V_{CR} representing the stored energy is used to drive one or more LEDs of a second color, e.g., the G LED (green LED). Without this saved energy that generates voltage V_{CR}, voltage V_{IN} would be used. Because voltage V_{CR} instead of voltage V_{IN} is used, energy is saved.

Resistor R_{S} is used to sense inductor current I_{L}. Circuit CS, based on current I_{L} flowing through resistor R_{S}, generates signal (e.g., voltage) C_{SE} based on which current direction controller I_{CTRL} generates signals C_{ML} and C_{MH} to turn on/off powered NMOS transistors M_{L} and M_{H}. In some embodiments, the magnitude of voltage C_{SE} (e.g., |C_{SE}|) is proportional to the magnitude of current I_{L}. Further, when current I_{L} is positive, voltage C_{SE} is positive, but when current I_{L} is negative, voltage C_{SE} is negative. The magnitude of current I_{L} (e.g., whether increasing or decreasing) depends on which of the two powered NMOS M_{L} or M_{H} is turned on. In effect, signal O_{CMP1} generated by amplifier CMP1 having voltage C_{SE} as an input limits the current I_{L} when |C_{SE}| is greater than signal |O_{EA1}|. Voltage C_{SE} together with circuit ZCD is also used to detect the zero current condition of current I_{L} (e.g., when |I_{L}| has decreased to zero from a positive current or increases to zero from a negative current). When current I_{L} is zero, voltage C_{SE} is zero. Zero current detector ZCD recognizing signal C_{SE} being 0 (i.e., I_{L} being 0) generates signal O_{ZCD} indicating a zero current condition based on which current controller I_{CTRL} generates signals C_{ML} and C_{MH}. For example, when |I_{L}| decreases to 0, current direction controller I_{CTRL} based on signal O_{CMP1} generates a high signal C_{ML} and a low signal C_{MH} to turn on the respective powered NMOS M_{L} and M_{H}. Turning on NMOS M_{L} and turning off NMOS M_{H} changes the flow of current I_{L} (e.g., from decreasing to increasing).

Inductor L_{M}, powered NMOS M_{H}, and powered NMOS M_{L} form a power converter providing voltage V_{O} to drive the array of multi-color LEDs. In the particularly illustrated embodiments, blue/red/green LEDs (BRG LEDs) are used in the array. However, LEDs of one or more other colors are used in some embodiments. Likewise, any other types of light emitting devices including, but not limited to, laser diodes or OELDs (organic electro luminescent device), are used in further embodiments. In some embodiments, when NMOS M_{L} is on NMOS M_{H} is off, and when NMOS M_{L} is off NMOS M_{H} is on. When NMOS M_{L} is on a current path is created and current I_{L} flows through NMOS M_{L} to ground. When NMOS M_{L} is off and NMOS M_{H} is on, the current I_{L} flows through NMOS M_{H} to the BRG LEDs. In some embodiments, powered NMOS M_{L} and M_{H} (as opposed to conventional NMOS transistors) are used to handle large current flowing through them.

Current controller I_{CRTL} controls the direction of energy flow or the direction of current I_{L}. In some embodiments, when I_{L} increases and is larger than zero current I_{L} flows in the positive direction, the amplitude of voltage C_{SE} (e.g., |C_{SE}|) increases, which is compared with the amplitude of signal O_{EA1} (e.g., |O_{EA1}|) to generate signal O_{CMP1} based on which current controller I_{CTRL} generates signals C_{ML} and C_{MH}. When I_{L} decreases, however, circuit ZCD, based on the zero current condition reflected on voltage C_{SE}, provides output O_{ZCD} based on which current controller I_{CTRL} generates signals C_{ML} and C_{MH}. For example, when |I_{L}| decreases to zero, |C_{SE}| decreases to 0, circuit ZCD detects a zero current condition of current I_{L} and generates appropriate signal O_{ZCD} based on which current controller I_{CTRL} generates a high signal C_{ML} to turn on NMOS M_{L}. In some embodiments, current controller I_{CTRL} generates a high signal C_{ML} and C_{MH} to turn on NMOS M_{L} and M_{H} respectively. When current I_{L} switches from the positive to the negative direction, the last zero current signal O_{ZCD} in the positive current I_{L} is skipped by the trigger signal S_{SCAN} to keep the status of NMOS M_{H} and M_{L}. That is, when current I_{L} decreases during the boundary between the positive and negative domain, the NMOS M_{H} and M_{L} are respectively on and off even though current I_{L} decreases to zero. When current I_{L} decreases in the negative domain (e.g., current I_{L} is negative), the amplitude of voltage C_{SE} (e.g., |C_{SE}|) increases and is compared with the amplitude of signal O_{EA1} (e.g., |O_{EA1}|) to generate signal O_{CMP1} based on which current controller I_{CTRL} generates signals C_{ML} and C_{MH} that are the inverse signals of those signals when current I_{L} is positive. For example, when |C_{SE}| is larger than |O_{EA1}|, NMOS M_{H} and M_{L} respectively turn off and on when current I_{L} is negative. When the |I_{L}| decreases to zero, circuit ZCD detects a zero current condition of current I_{L} and generates appropriate signal O_{ZCD} based on which current controller I_{CTRL} generates a high signal C_{ML} to turn off NMOS M_{L}. When current I_{L} switches from negative to positive, the last zero current signal O_{ZCD} when current I_{L} is negative is skipped by the positive signal O_{EA1} to keep the status of NMOS M_{H} and M_{L}.

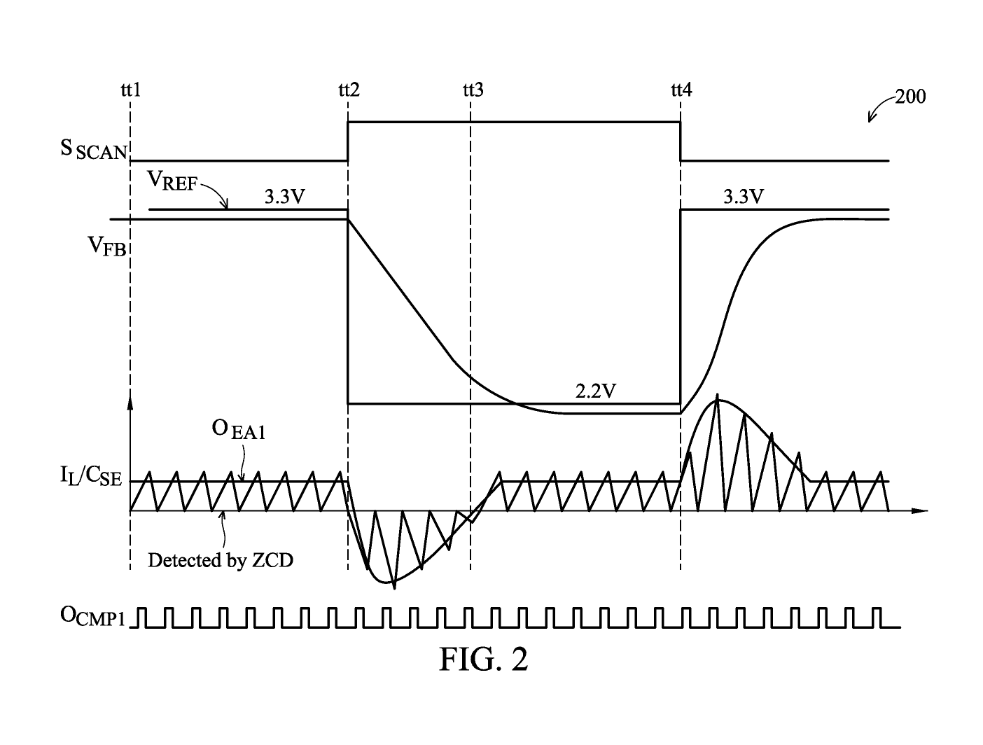

Signal S_{SCAN} acting as a trigger signal synchronizes control signals C_{ML} and C_{MH} through current controller I_{CRTL}. Signal S_{SCAN} through the current directional controller I_{CTRL} and driver Drv generates signals C_{ML} and C_{MH} to control NMOS M_{L} and M_{H} respectively. Signal S_{SCAN} includes signals B_{SCAN}, R_{SCAN}, and G_{SCAN} (shown in FIG. 2) corresponding to the respective B, R and G LEDs. In some embodiments, signal S_{SCAN}, via signal R_{SCAN} transitioning from a low to a high, triggers the energy recycling mode. Further, signals B_{SCAN}, R_{SCAN}, and G_{SCAN} when transitioning from a low to a high indicate the respective LED transitioning from the Data phase to the Wait phase, and when transitioning from a high to a low indicate the end of the Display phase for the corresponding LED.

Driver Drv controls (e.g., turn on/off) powered NMOS M_{L} and M_{H}. Driver Drv acts as a buffer for current controller I_{CTRL} and sends control signals C_{ML} and C_{MH} to control powered NMOS M_{L} and M_{H}, respectively. In some embodiments, signals C_{ML} and C_{MH} are reverse logics so that when NMOS M_{L} is on, NMOS M_{H} is off and vice versa. When signal C_{ML} is high, signal C_{MH} is low turning NMOS M_{L} and M_{H} on and off, respectively. When signal C_{ML} is low, signal C_{MH} is high turning NMOS M_{L} and M_{H} off and on, respectively.

Capacitor C_{O} is used to filter the ripples, if any, existed on voltage V_{O}, and provides a stable voltage V_{O}.

Voltage V_{O} commonly called a driving voltage (e.g., driving the LEDs) provides the voltage/current to light the RGB LEDs. The voltage level of voltage V_{O} depends on the number of LEDs driven by voltage V_{O}. The higher the number of LEDs, the higher the voltage level for voltage V_{O}. In some embodiments, the high voltage of V_{O} is 40V for 12 LEDs, but this voltage is about 30V for 8 LEDs, for example. In some embodiments, voltage V_{O} dynamically switches for a corresponding R, G, or B LED. Further, when V_{O} switches from a high voltage level towards a low voltage level (e.g., when the R LED transitions from the Data phase to the Wait phase), the charge due to the voltage drop is stored in capacitor (e.g., energy tank) C_{R}. When an LED demands energy (e.g., the G LED transitions from the Data phase to the Wait phase), the saved charge (e.g., energy) is used to generate the 40V high voltage level to drive the G LED. Because the saved energy is reused, energy is saved for circuit 100 as a whole.

In some embodiments, if ΔV_{O} is the change in voltage V_{O}, and ΔV_{CR} is the change in voltage V_{CR}, then

ΔV_{O}*C_{O}=ΔV_{CR}*C_{R} or

ΔV_{CR}=ΔV_{O}*C_{O}/C_{R}

Further, so that the driving voltage (e.g., output voltage) V_{O} is greater than the supply voltage (e.g., or V_{CR}),

V_{O}−ΔV_{O}>V_{CR}+ΔV_{CR} or

V_{O}>V_{CR}+ΔV_{CR}+ΔV_{O} or

V_{O}>V_{CR}+ΔV_{O}*(C_{O}/C_{R})+ΔV_{O} or

V_{O}>V_{CR}+ΔV_{O}(1+C_{O}/C_{R})

The plurality of G, B, and R LEDs in some embodiments is used as backlights for a LED-backlit LCD display device or are used to directly display images in an LED display device, such as an LED television screen. Further, there are 12 LEDs for each G, B, and R color, but the embodiments are not limited to any particular number of LEDs. Each B, R, or G LED includes a data receiving phase (e.g., “Data”), a waiting phase (e.g., “Wait”) and a display phase (e.g., “Display”). In the Data phase the LED, either B, R, or G, is “addressed,” i.e., the system/circuit (e.g., a television) using the LEDs locates the appropriate LED. In the Wait phase, the television waits for the LCD image rotation to the appropriate position, and in the Display phase, the LED is turned on. Additionally, the forward (e.g., turn on) bias voltage for the G, B, and R LEDs are 3.3V, 3.3V, and 2.2V, respectively. In some embodiments, the B, R, and G LEDs are controlled to pass through the Data, the Wait, and the Display phases by the television using the LEDs.

PWM current controller receives dimming control signal DIMCTRL to control the duty cycle and the current of each B R or G LED. An LED using a higher current is brighter than an LED having a lower current. An LED is turned on/off depending on the duty cycle or the logic level of the corresponding pulse width in PWM current controller. For example, if the pulse width is high, the LED turns on, but if the pulse width is low, the LED turns off.

Resistors R₁ and R₂ serve as a voltage divider for voltage V_{O} to generate voltage V_{FB}. When voltage V_{O} changes, voltage V_{FB} changes. Voltage V_{FB} is used to compare with a corresponding reference voltage V_{R}, V_{B}, or V_{G} reflecting through voltage V_{REF}.

Error amplifier EA1 compares voltage V_{FB} to one of reference voltages V_{R}, V_{B}, or V_{G} chosen as voltage V_{REF}, and provides signal O_{EA1}. Switches S_{R}, S_{B}, or S_{G} are used to select the corresponding voltages V_{R}, V_{B}, or V_{G} as the reference voltage V_{REF} for amplifier EA1. For example, when switch S_{R} is closed the corresponding voltage V_{R} is selected as reference voltage V_{REF}. When switch S_{B} is closed the corresponding voltage V_{B} is selected as reference voltage V_{REF}, and when a switch S_{G} is closed the corresponding voltage V_{G} is selected as reference voltage V_{REF}, etc. In some embodiments, when the LED lighting sequence is B, R, and G, voltage V_{REF} following voltages V_{B}, V_{R}, and V_{G} has a wave form of High (H) Low (L) High (H) where the H, L, H correspond to V_{B}, V_{R}, and V_{G}, which is 3.3V, 2.2V, and 3.3V respectively. Signal S_{SCAN} that includes signals B_{SCAN}, R_{SCAN}, G_{SCAN} (shown in FIG. 2) corresponding to the B, R, G LEDs, controls the respective switches S_{B}, S_{R}, and S_{G}. For example, when signal B_{SCAN} is high, switch S_{B} closes and signal V_{B} is used as a reference voltage V_{REF} for error amplifier EA1. When signal R_{SCAN} is high, switch S_{R} closes and signal V_{R} is used as a reference input for amplifier EA1. When signal G_{SCAN} is high, switch S_{G} closes and signal V_{G} is used as a reference input for amplifier EA1, etc. Amplifier EA1 generates signal O_{EA1} based on the difference between signals V_{FB} and V_{REF}. In some embodiments, when V_{FB} is lower than V_{REF}, signal O_{EA1} is high, and when V_{FB} is higher than V_{REF}, signal O_{EA1} is low or negative.

Comparator CMP1 compares signal O_{EA1} with voltage C_{SE} and provides signal O_{CMP1} to control the direction of current I_{L}. In some embodiments, comparator CMP1 generates signal O_{CMP1} to stop |I_{L}| from increasing when |I_{L}| reaches a level that |C_{SE}| is higher than |O_{EA1}|. In some embodiments, whenever |C_{SE}| is higher than |O_{EA1}|, O_{CMP1} is high and current controller C_{CTRL} generates a low signal C_{ML} and a high signal C_{MH} to turn off M_{L} and turn on M_{H}. Turning off M_{L} and turning on M_{H} changes the flow of current I_{L} (e.g., from increasing to decreasing).

### ILLUSTRATIVE WAVEFORMS

FIG. 2 is a graph of waveforms 200 illustrating the relationship between various signals for circuit 100, in accordance with some embodiments. In this illustration, circuit 100 is in the energy recycle mode in the period between time tt2 and tt3.

In FIG. 2, whenever |C_{SE}| is greater than |O_{EA1}|, signal O_{CMP1} is high, and signal C_{SE} corresponding current I_{L} changes the flow from increasing to decreasing or from decreasing to increasing. Similarly, whenever |C_{SE}| reaches 0 indicating the zero current condition for current I_{L}, |C_{SE}| and |I_{L}| also changes the flow from increasing to decreasing or from decreasing to increasing.

In effect, signals O_{CMP1} and O_{ZCD} set the respective maximum and minimum values for |C_{SE}|. Considering the real value including the sign (e.g., positive/negative), when current I_{L} is in the positive domain (e.g., prior to time tt2 and after time tt3), signals O_{CMP1} and O_{ZCD} set the respective maximum and minimum amplitude for signal C_{SE}. But when current I_{L} is in the negative domain (e.g., time period between time tt2 and tt3, signals O_{CMP1} and O_{ZCD} set the respective minimum and maximum amplitude for signal C_{SE}.

In some embodiments where current I_{L} is in the negative domain and signal O_{EA1} is not generated as a negative voltage for comparator CMP1, a timer is used to generate signal O_{CMP1} having a fixed time pulse.

### THE BOOST MODE

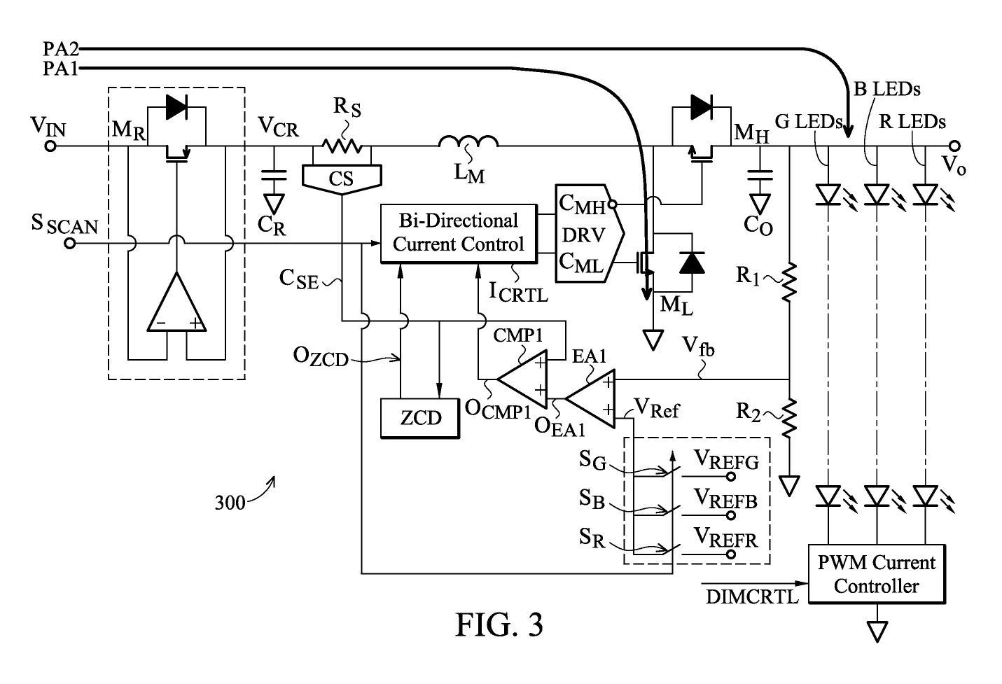

FIG. 3 is a schematic diagram 300 illustrating the operation of circuit 100 in the boost mode, in accordance with some embodiments.

In the boost mode, voltage V_{IN} is used as the voltage source to generate voltage V_{O}. In some embodiments, voltage V_{CR} is initially 0V while voltage V_{IN} is 12V. Because voltage V_{IN} is greater than voltage V_{CR}, diode M_{R} turns on, current I_{L} flows in the positive domain, e.g., in direction D_{IO}, but through two different paths, path PA1 and path PA2. Further, current I_{L} flows through path PA1 first because the power converter comprising inductor L_{M} and two NMOS M_{L} and M_{H} first stores the energy in inductor L_{M} that causes current I_{L} to increase. The power converter then converts the stored energy to output V_{O} and switches back and forth between paths PA1 and PA2. In path PA1 NMOS M_{H} is off while NMOS M_{L} is on, and current flows through M_{L}. Current I_{L} increases from 0V to its peak level determined by signal O_{EA1}. That is, current I_{L} increases until voltage C_{SE} is greater than voltage O_{EA1}. At that time, comparator CMP1 generates a high signal O_{CMP1}, and current direction controller I_{CTRL}, based on the high O_{CMP1}, generates a low signal C_{ML} to turn off M_{L} and turn on M_{H}. When M_{H} turns on current I_{L} flows through path PA2 and turns on the corresponding LED. Because the LED lights and consumes energy, current I_{L} starts to decrease, and causes voltage C_{SE} to decrease until circuit ZCD, based on voltage C_{SE}, detects the zero current condition and provides the corresponding signal O_{ZCD} (e.g., high). Current direction controller I_{CTRL}, based on signal O_{ZCD}, generates a high signal C_{ML} to turn on M_{L} for current I_{L} to flow through path PA1. Current switching between paths PA1 and PA2 continues until circuit 100 is out of the boost mode.

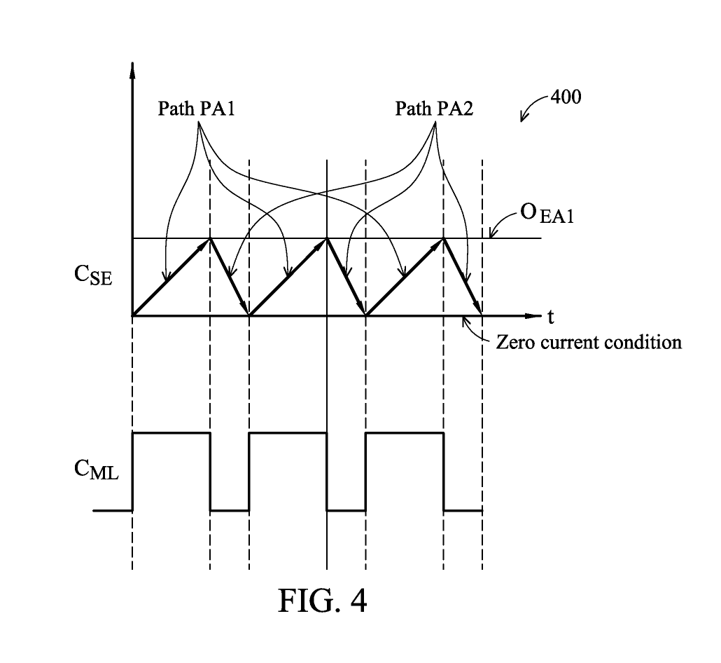

FIG. 4 is a graph of waveforms 400 illustrating the relationship of various currents and voltages corresponding to the operation of circuit 100 in FIG. 3, in accordance with some embodiments. During the time signal C_{ML} is high NMOS M_{L} is on, current I_{L} flows through path PA1 and its magnitude increases until voltage C_{SE} reaches (e.g., a little higher) than signal O_{EA1}. In contrast, during the time signal C_{ML} is low, NMOS M_{L} is off, NMOS M_{H} is on. Current I_{L} flows through path PA2, and decreases until the zero current condition occurs.

### THE ENERGY RECYCLING MODE

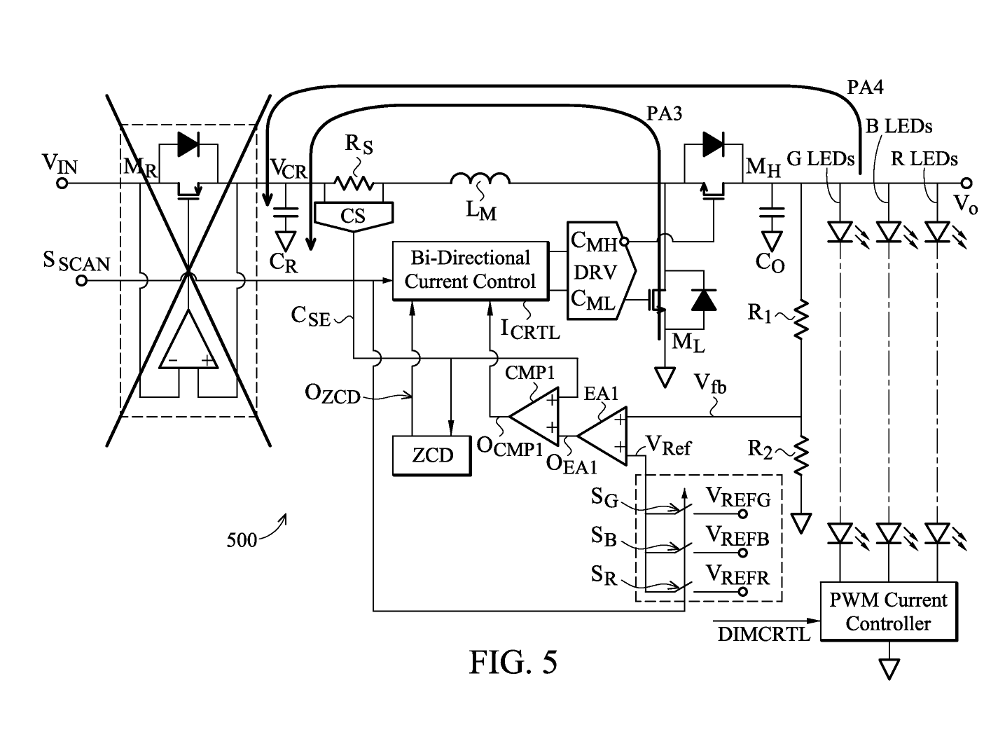

FIG. 5 is a schematic diagram 500 illustrating circuit 100 in the energy recycling mode, which follows a boost mode as illustrated in FIG. 3. When voltage V_{O} starts dropping from a high voltage level (e.g., 40V) toward a low (e.g., 26V) (e.g., when the R LED transition from the Data phase to the Wait phase), some embodiments save the energy (e.g., the charge) resulting from this voltage drop. In this illustration, the power converter comprising inductor L_{M} and two NMOS M_{L} and M_{H} switches to the “buck” mode operation in which voltage V_{CR} is “stepped down” from about 40V of the output V_{O} to about 19V. Current I_{L} flows in direction D_{OI}, which is trigged by the signal S_{SCAN} and ended by signal O_{EA1}. Current I_{L} flows through two different paths, e.g., path PA3 and path PA4. Because current I_{L} flows in direction D_{OI}, it's a negative current. Current I_{L} flowing through inductor L_{M} generates the energy stored by capacitor C_{R}. Stated another way, current I_{L} harvests the charge resulting from the voltage drop to the energy tank C_{R}. As |I_{L}| increases, voltage V_{CR} increases until it's higher than voltage V_{IN}, diode M_{R} turns off. Because, in some embodiments V_{R} is about 0.2 V less than voltage V_{IN}, it does not take too long from the time current I_{L} flows in the D_{OI} direction for diode M_{R} to turn off.

In some embodiments, current I_{L} flows through path PA4 first because the boundary between the positive and negative domain is current path PA2 in the boost mode and current path PA4 in this energy recycling mode. Current I_{L} also switches back and forth between paths PA4 and PA3. In path PA4 NMOS M_{H} is on while NMOS M_{L} is off, and current flows through M_{H}. The |I_{L}| increases (or current I_{L} decreases) from 0V to its peak level determined by signal O_{EA1}. That is, |I_{L}| increases until |C_{SE}| is greater than |O_{EA1}|. At that time, current direction controller I_{CTRL} generates a high signal C_{ML} to turn on M_{L} and turn off M_{H}. When M_{L} turns on current I_{L} flows through path PA3. |I_{L}| starts to decrease causing |C_{SE}| to decrease until circuit ZCD detects the zero current condition through voltage C_{SE} from which current direction controller I_{CTRL} generates a low signal C_{ML} to turn off M_{L} for current I_{L} to flow through path PA3. Current switching between paths PA3 and PA4 continues until circuit 100 is out of the energy recycle mode.

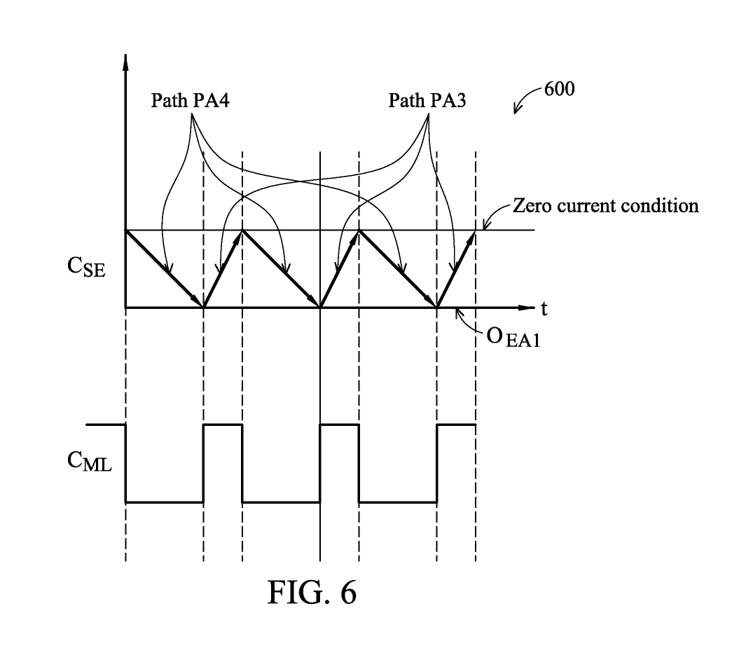

FIG. 6 is a graph of waveforms 600 illustrating the relationship of various currents and voltages corresponding to the operation of circuit 100 in FIG. 5, in accordance with some embodiments. During the time signal C_{ML} is low NMOS M_{L} is off, current I_{L} flows through path PA4 and |I_{L}| increases until |C_{SE}| reaches (e.g., a little higher than) |O_{EA1}|. In contrast, during the time signal C_{ML} is high, NMOS M_{L} is on, NMOS M_{H} is off. Current I_{L} flows through path PA3, and |I_{L}| decreases until the zero current condition occurs.

In some embodiments, current direction controller I_{CTRL} includes a time constant T_{CONST} to limit the time current I_{L} flows through path PA4. Even if the zero current condition has not occurred but if the time from which |I_{L}| starts increasing has passed the time constant T_{CONST}, current direction controller I_{CTRL} also generates signal C_{ML} (e.g., a low) to turn off NMOS M_{L}.

### THE SILENCE MODE

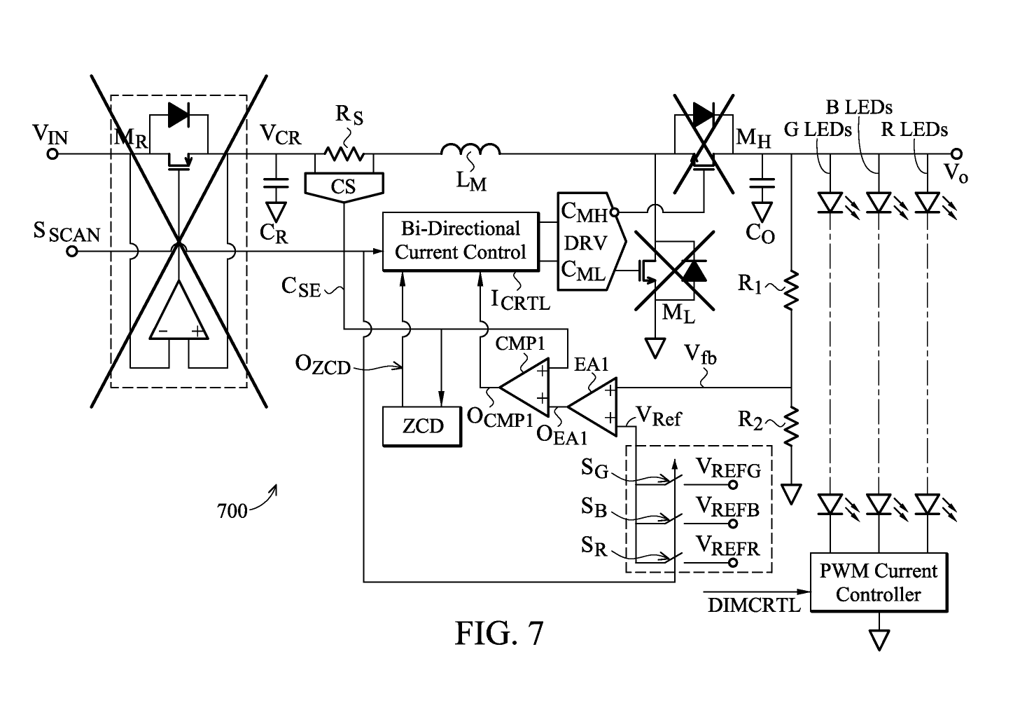

FIG. 7 is a schematic diagram 700 illustrating circuit 100 in the silence mode that follows an energy recycle mode as illustrated in FIG. 5, in accordance with some embodiments. When voltage node V_{O} does not demand energy (e.g., voltage/current) for the LEDs (e.g., the R LED is in the Wait phase), current I_{L} is zero, circuit 100 switches to the silence mode. In this illustration, because circuit 100 has just come out of the energy recycling mode, voltage V_{CR} is greater than voltage V_{IN}, diode M_{R} turns off. Additionally, because there is not any current I_{L}, both M_{H} and M_{L} turn off. During the silence mode the energy (the charge) is hold in the energy tank C_{R}.

### THE ENERGY TRANSFER MODE

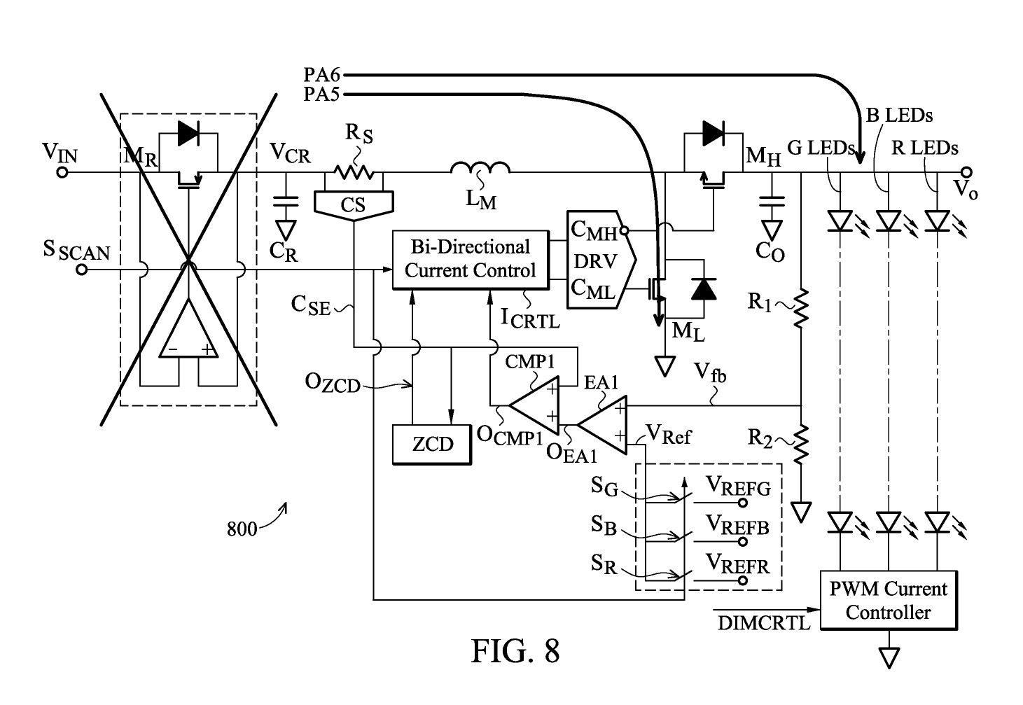

FIG. 8 is a schematic diagram 800 illustrating the operation of circuit 100 in the energy transfer mode that follows the silence mode as illustrated in FIG. 7, in accordance with some embodiments. In the energy transfer mode, voltage V_{CR} from the energy tank C_{R}, instead of voltage V_{IN}, is used as an input to generate voltage V_{O}. In FIG. 8, because circuit 100 has just come out of the silence mode, voltage V_{CR} remains greater than voltage V_{IN}, diode M_{R} turns off. Current I_{L} flows in direction D_{IO} through an LED (e.g., the R LED) that lights the LED. Because voltage V_{CR} is used as an input, the saved charge in capacitor C_{R} during the energy-recycle mode is transferred to node V_{O} to drive the corresponding LED (e.g., R LED). The operation in this mode is the same as in the boost mode except voltage V_{CR} instead of voltage V_{IN} is used as an input. As a result, the current paths PA5 and PA6 correspond to the respective current paths PA1 and PA2. Once the saving energy is fully transferred, i.e., the charge stored in capacitor C_{R} has exhausted, voltage V_{CR} drops until V_{IN} is greater than V_{CR}. At that time, active diode M_{R} turns on and circuit 100 returns to the boost mode, i.e., voltage V_{IN} functions in place of voltage V_{CR}.

### ILLUSTRATIVE WAVEFORMS

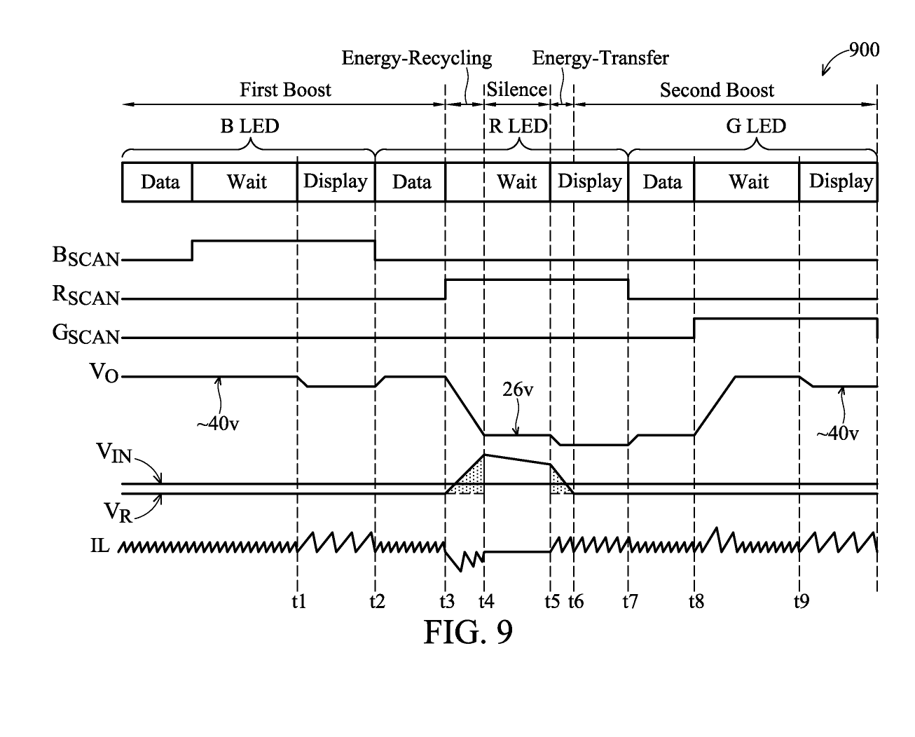

FIG. 9 is a graph of waveforms 900 illustrating an operation of circuit 100 in accordance with some embodiments. In this illustration, circuit 100 transitions through an operation cycle including a first boost mode, an energy-recycling mode, a silence mode, an energy transfer mode, and a second boost mode. The operation cycle corresponds to the sequential operation of three B, R, and G LEDs, each of which transitions through the Data, the Wait, and the Display phases.

When signals B_{SCAN}, R_{SCAN}, and G_{SCAN} rise from a low to a high the respective B, R, and G LEDs transition from the Data phase to the Wait phase. That is, the LEDs have been addressed and the LCDS for the LEDs enter the LCD rotation mode. The system (e.g., the television) using the LEDs waits for the LEDs to be ready for lighting. When signals B_{SCAN}, R_{SCAN}, and G_{SCAN} fall from a high to a low, the corresponding LEDs have been displayed for the particular operation cycle. At the beginning of the first boost mode (e.g., prior to time t1) and at the end of the second boost mode (e.g., a little after time t6), voltage V_{O} is at the high logic level (e.g., about 40V).

At time t1, the B LED is in the Display mode. Voltage V_{O} drops a little because of the current demand for displaying, but still stays around the 40V range. The B LED turns on. Current I_{L} switches in the positive domain, having the peak controlled by voltage V_{O}, V_{FB}, and O_{EA1}. Current I_{L} is in the cycle of increasing, decreasing, increasing, etc., reflecting the current paths PA1 and PA2 in FIG. 3. The amplitude of current I_{L} during the Display phase (e.g., between time t1 and time t2), however, is higher than that of the other phases (e.g., B Data, B Wait, and R Data phases) because displaying demands higher current.

At time t2, after the B LED has been displayed, the R LED is in the Data phase (e.g., the television addresses the R LED). |I_{L}| drops to about 0V like in the time period prior to time t1 because the high current demand for displaying the B LED has ended.

At time t3, in some embodiments, when the R LED transitions from the Data to the Wait phase, signal R_{SCAN} (e.g., the scan signal for the R LED) reaches a high voltage V_{O} starts dropping from 40V towards 26V, circuit 100 enters the energy recycling mode. As a result, current I_{L} switches in the negative domain in direction D_{OI}. The amplitude of current I_{L} in the repeated cycles of increasing then decreasing reflects the current paths PA3 and PA4 in FIG. 4. Voltage V_{CR} increases because |I_{L}| increases and the negative current I_{L} is the charging current that causes voltage V_{CR} to increase.

At time t4, after the energy-recycling mode ends, circuit 100 enters the silence mode where the energy is stored in the energy tank until time t5. In this mode, between times t4 and t5, voltage V_{O} remains at the low of 26V, but circuit 100 does not experience any activity because the television is waiting for the R LED to be displayed. As a result, current I_{L} remains at 0 A without switching. Voltage V_{CR} slopes a little around the voltage acquired during the energy recycling mode because of some current leakage in circuit 100.

At time t5, the R LED is displayed, which demands energy (e.g., voltage/current at V_{O}). Circuit 100 enters the energy-transfer mode. That is, circuit 100 uses the energy stored in energy tank C_{R} (e.g., voltage V_{CR}) to generate voltage V_{O} to display the R LED. Current I_{L} starts switching in the positive domain using the current paths P5 and P6 in FIG. 8. As the energy is consumed, voltage V_{CR} starts decreasing until the saved energy in energy tank C_{R} is exhausted. At that time, circuit 100 ends its energy transfer mode.

At time t6, because the saved energy has been exhausted, circuit 100 enters the boost mode (e.g., the second boost mode) to use voltage V_{IN} to continue generating voltage V_{O} and thus continues displaying the R LED. As a result, current I_{L} still switches in the positive domain in direction D_{IO}.

At time t7 the R LED ends its Display phase and the G LED enters the Data phase, which does not demand much current. |I_{L}|, as a result, decreases.

At time t8, the G LED enters its Wait phase, demanding voltage V_{O}. Voltage V_{O} starts to increase until it reaches 40V some time later in the Wait phase, and remains around 40V during the Wait and Display phases of the G LED. During the time voltage V_{O} increases, |I_{L}| increases, and decreases when voltage V_{O} stables at 40V.

At time t9, the G LED enters its Display phase, circuit 100 having been in the second boost mode uses voltage V_{IN} to generate voltage V_{O}. Because the G LED is in the Display phase, |I_{L}| increases.

In the above illustration, current I_{L} switches in the positive domain or flows in direction D_{IO} in time periods prior to time t3 and subsequent to time t4, and flows in the direction D_{OI} in the period between times t3 and t4, which is consistent with the fact that in the energy recycling phase current flows in an opposite direction with the current flow in other phases.

### EXEMPLARY METHOD

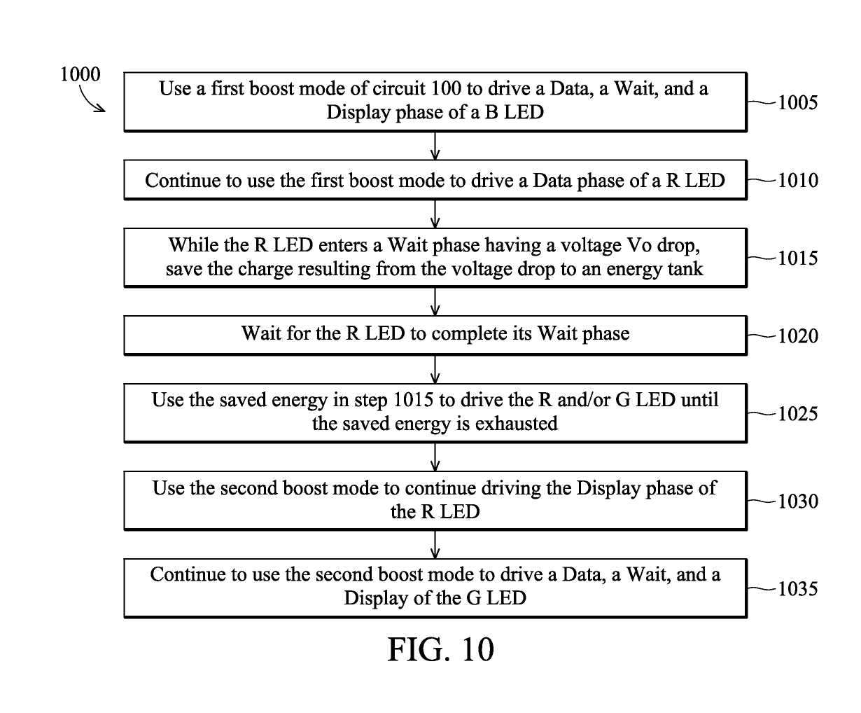

FIG. 10 is a flow chart 1000 illustrating a method related to circuit 100, in accordance with some embodiments.

In step 1005, a first boost mode of circuit 100 is used to drive a Data, a Wait, and a Display phase of a B LED.

In step 1010, the first boost mode continues to drive a Data phase of a R LED.

In step 1015, while the R LED enters a Wait phase having a voltage V_{O} drop, the charge resulting from the voltage drop to is saved to an energy tank.

In step 1020, the television waits for the R LED to complete its Wait phase.

In step 1025, the saved energy in step 1015 is used to continue driving the R and/or G LED until the saved energy is exhausted. For illustration, the saved energy is exhausted before the Display phase of the R LED.

In step 1030, the second boost mode is used to continue driving the Display phase of the R LED.

In step 1035, the second boost mode is used to continue driving a Data, a Wait, and a Display phase of the G LED.

### EXEMPLARY ADVANTAGE

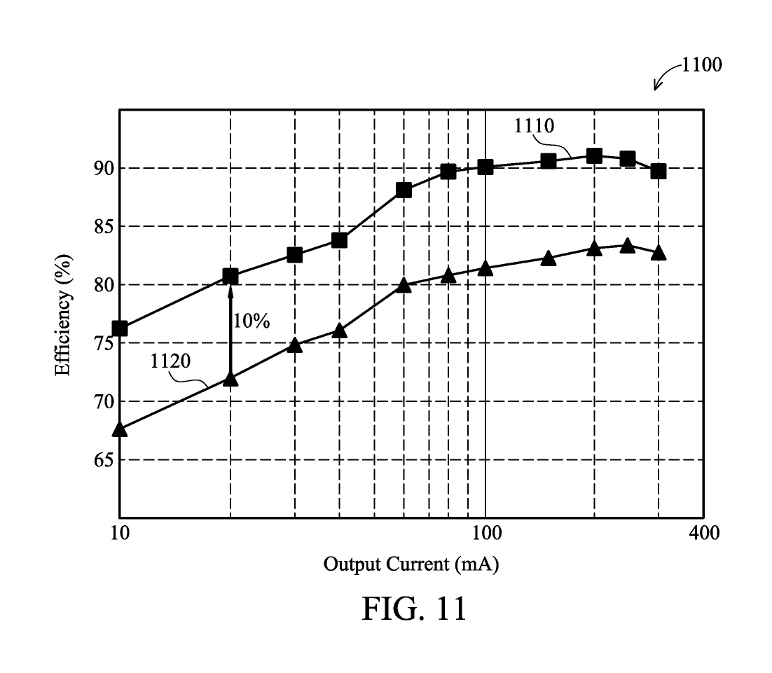

FIG. 11 is a graph of waveforms 1100 illustrating an advantage of circuit 100, in accordance with some embodiments. The X-axis shows the output current (e.g., current I_{O}), which is the current at node V_{O} flowing into the corresponding LEDs, in milli Amperes (mA) in a log scale. The Y-axis shows the efficiency in terms of the ratio between the output power P_{O} and the input power P_{I} wherein P_{O}=V_{O}*I_{O} and P_{I}=V_{IN}*the input current. In an ideal situation, PO/PI=100%. Line 1110 represents the efficiency with respect to output current I_{O} without the energy saving mechanism of circuit 100. Line 1120 represents the efficiency with respect to current I_{O} with the energy saving mechanism of circuit 100. As shown in FIG. 11, circuit 100 (line 1120) is about 10% better than a circuit without using the energy saving mechanism.

A number of embodiments have been described. It will nevertheless be understood that various modifications may be made without departing from the spirit and scope of the invention. For example, the various transistors being shown as a particular dopant type (e.g., NMOS and PMOS) are for illustration purposes, embodiments of the disclosure are not limited to a particular type, but the dopant type selected for a particular transistor is a design choice and is within the scope of embodiments. The logic level (e.g., low or high) of the various signals used in the above description is also for illustration purposes, embodiments are not limited to a particular level when a signal is activated and/or deactivated, but, rather, selecting such a level is a matter of design choice.

The various figures show the resistors and capacitors (e.g., resistors R1, R2, capacitors C_{R}, C_{O}, etc.) using discrete resistors and capacitors for illustration only, equivalent circuitry may be used. For example, a resistive device, circuitry or network (e.g., a combination of resistors, resistive devices, circuitry, etc.) can be used in place of the resistor. Similarly, a capacitive device, circuitry or network (e.g., a combination of capacitors, capacitive devices, circuitry, etc.) can be used in place of the capacitor. Additionally, other devices, networks, etc., including rechargeable batteries, that store energy (e.g., charge) can be used in place capacitor or energy tank C_{R}.

Circuit 100 with exemplary voltage levels of 40V, 26V, etc., is used for illustration. Some embodiments include other circuits that use multiple voltage levels, including, for example, 30V, 20V, 15V, etc. Embodiments of this disclosure are not limited to any number of voltage levels or a particular value for a level. The energy recycling mode is illustrated when voltage V_{O} decreases, but principles of the disclosed embodiments are applicable when the voltage increases. Further, the disclosed embodiments can be used in programmable DC power supplies (such as the Agient N6705A), sequential power applications, traffic LED lights, advertising lights, etc.

The above method embodiment shows exemplary steps, but they are not necessarily performed in the order shown. Steps may be added, replaced, changed order, and/or eliminated as appropriate, in accordance with the spirit and scope of disclosed embodiments.

Each claim of this document constitutes a separate embodiment, and embodiments that combine different claims and/or different embodiments are within scope of the disclosure and will be apparent to those of ordinary skill in the art after reviewing this disclosure.

What is claimed is:

1. A method comprising:
using an input voltage to generate an output voltage having a first voltage level;
in a first period, when the output voltage changes from the first voltage level to a second voltage level, storing electrical charges resulted from the output voltage changing from the first voltage level to the second voltage level; and
in a second period subsequent to the first period when the output voltage demands energy, using a voltage generated from the stored electrical charges in place of the input voltage to generate the output voltage.

2. The method of claim 1 further comprising using a first mode of a plurality of modes of a circuit that receives the input voltage and provides the output voltage to drive a first phase, a second phase, and a third phase of a first LED, and a first phase of a second LED.

3. The method of claim 2 further comprising using a second mode of the plurality of modes of the circuit to drive a second phase of the second LED when the output voltage changes from the first level to the second level.

4. The method of claim 3 further comprising using a third mode of the plurality of modes of the circuit to continue driving the second phase of the second LED.

5. The method of claim 4 further comprising using a fourth mode the plurality of modes of the circuit to drive one or a combination of a third phase of the second LED, a first phase of a third LED, a second phase of the third LED, or a third phase of the third LED.

6. The method of claim 4 further comprising using the first mode of the plurality of modes of the circuit to drive a third phase of the second LED.

7. A circuit comprising:
an input node configured to provide an input voltage;
an energy node coupled to an energy tank;
a device configured to electrically connect the energy node to or electrically disconnect the energy node from the input node;
an output node configured to provide an output voltage; and
a power converter circuit coupled between the energy node and the output node;
wherein
when the output voltage changes from a first voltage level to a second voltage level, the power converter circuit is configured for storing, in the energy tank, charges resulted from the output voltage changing from the first voltage level to the second voltage level; and
when the output node demands energy, the power converter circuit is configured for using a voltage at the energy node to generate the output voltage at the output node.

8. The circuit of claim 7 further comprising a plurality of LEDs driven by the output voltage.

9. The circuit of claim 7 further comprising a feedback circuit coupled between the output node and the power converter circuit to change a direction of a current in the power converter circuit toward the output node or toward the energy node.

10. The circuit of claim 9 wherein the direction of the current is based on a zero condition of the current or on a voltage level proportional to the current against a reference voltage.

11. The circuit of claim 7 being configured to operate in
a first mode when the device is configured to electrically connect the input node to the energy node;
in a second mode when the device is configured to electrically disconnect the input node from the energy node and when the output voltage changes from the first voltage level to the second voltage level;
in a third mode when the power converter circuit is off; and
in a fourth mode when the power converter circuit is configured for using the voltage at the energy node to generate the output voltage.

12. The circuit of claim 11 being configured to operate in a sequence of the first mode, the second mode, the third mode, and the fourth mode to drive a sequence of a B LED, a R LED, and a G LED.

13. The circuit of claim 7 wherein the power converter circuit comprises
an inductor coupled to a first switch and a second switch, the first switch is configured for an amplitude of a current flowing to the inductor to increase and the second switch is configured for the amplitude of the current to decrease.

14. The circuit of claim 7 wherein the first voltage level is higher than the second voltage level.

15. A circuit comprising:
an input node configured to provide an input voltage;
a device coupled to the input node;
an energy node coupled to the device and to an energy tank; the device configured to electrically connect the energy node to or electrically disconnect the energy node from the input node;
a sensing circuit coupled to the energy node;
a power converter circuit coupled to the sensing circuit;
an output node coupled to the power converter circuit and configured to provide an output voltage;
a feed back circuit coupled between the output node and the sensing circuit
wherein
when the output voltage changes from a first voltage level to a second voltage level, the power converter circuit is configured for storing, in the energy tank, charges resulted from the output voltage changing from the first voltage level to the second voltage level;
when the output node demands energy, the power converter circuit is configured for using a voltage at the energy node to generate the output voltage at the output node; and
the feedback circuit, based on an output of the sensing circuit, is configured for causing the power converter circuit to increase or to decrease an amplitude of a current in the power converter circuit.

16. The circuit of claim 15 wherein the power converter comprises an inductor coupled to a first powered NMOS and a second powered NMOS,
when the first powered NMOS is configured to be on, the second powered NMOS is configured to be off, and
when the first powered NMOS is configured to be off, the second powered NMOS is configured to be on.

17. The circuit of claim 15 further comprising a plurality of LEDs driven by the output voltage.

18. The circuit of claim 15 being configured to operate in
a first mode when the device is configured to electrically connect the input node to the energy node;
in a second mode when the device is configured to electrically disconnect the input node from the energy node and when the output voltage changes from the first voltage level to the second voltage level;
in a third mode when the power converter circuit is off; and
in a fourth mode when the power converter circuit is configured for using the voltage at the energy node to generate the output voltage.

19. The circuit of claim 15 wherein the first voltage level is higher than the second voltage level.

20. The circuit of claim 15 wherein
the sensing circuit detects a zero condition of the current or a voltage level proportional to the current against a reference voltage; and
the feedback circuit, based on the detected zero condition of the current or the detected voltage level proportional to the current against the reference voltage, is configured for causing the power converter circuit to increase or to decrease the amplitude of the current, respectively.
